(19) United States
(12) Patent Application Publication
(10) Pub. No.: US 2005/0281267 A1
(43) Pub. Date: Dec. 22, 2005

(54) ATM switching protocol

(76) Inventors: Gordon McFadden, Hillsboro, OR (US); Soni Goel, Simi Valley, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/873,693

(22) Filed: Jun. 22, 2004

(51) Int. Cl. H04L 12/28

(52) U.S. Cl. 370/395.1

(57) ABSTRACT

Described are a system and method of forwarding ATM cells among component boards in a computing platform. ATM cells received at an ingress media port of component board may be forwarded to a destination component board in a payload portion of an Ethernet data frame comprising at least one field identifying an egress port of a destination component board for transmitting the forwarded ATM cells.

### BACKGROUND

1. Field

The subject matter disclosed herein relates to modular computing platform technology. In particular, the subject matter disclosed herein relates to the coupling of component boards by an Ethernet switch.

2. Information

Asynchronous Transfer Mode (ATM) provides network technology based on transferring data in cells of a fixed data size as provided in specifications set forth by the International Telecommunications Union (ITU) and the ATM Forum. The cell used to provide ATM services is relatively small compared to units used with older technologies. The small, constant cell size allows ATM equipment to transmit video, audio, and computer data over the same network, and assure that no single type of data consumes all of the data transmission resources of the network. ATM services can be provided to subscribers over a variety of transmission links such as, for example, digital subscriber line (DSL) links or Synchronous Optical NETwork (SONET) links.

Service provider networks typically operate specialized equipment to provide ATM related services to network clients. Such specialized equipment is typically capable of provisioning multiple services from a single ATM source (e.g., data link) in a wide area network (WAN). For example, the specialized equipment may provide a voice data (e.g., telephony) service, video content distribution service or Internet service to clients from a single source of ATM signals. The PCI Industrial Computer Manufacturers Group (PICMG) defines embedded computing platform architectures that have been proposed for use in connection with specialized telecommunication equipment. In particular, PICMG has defined an Advanced Telecommunications Computing Architecture (ATCA) PICMG Specification 3.0, January 2003 in which a modular computing platform may comprise several modular component boards coupled to a common backplane.

The ATM Forum has set forth a protocol for the transmission of data in Ethernet frames to provide ATM services in Frame-based ATM Transport over Ethernet (FATE), AF-FBATM-0139.001, July 2002. In particular, a local area network (LAN) constructed from Ethernet links can be coupled to an ATM network by a converter. The converter may be coupled to the ATM network backbone by an xDSL modem connection. ATM services may then be provided to end stations through the Ethernet links.

### BRIEF DESCRIPTION OF THE FIGURES

Non-limiting and non-exhaustive embodiments of the present invention will be described with reference to the following figures, wherein like reference numerals refer to like parts throughout the various figures unless otherwise specified.

FIG. 1 shows a modular computing platform comprising a plurality of component boards according to an embodiment of the present invention.

FIG. 2 shows a topology of a system employing a modular computing platform as illustrated in FIG. 1 to provide ATM services.

FIG. 3 illustrates a protocol for transmitting ATM cells between component boards through an Ethernet switch according to an embodiment of the modular computing platform shown in FIG. 1.

FIG. 4 shows a format for an Ethernet frame for transmitting ATM cells between component boards according to an embodiment of the modular computing platform shown in FIG. 1.

### DETAILED DESCRIPTION

Reference throughout this specification to “one embodiment” or “an embodiment” means that a particular feature, structure, or characteristic described in connection with the embodiment is included in at least one embodiment of the present invention. Thus, the appearances of the phrase “in one embodiment” or “an embodiment” in various places throughout this specification are not necessarily all referring to the same embodiment. Furthermore, the particular features, structures, or characteristics may be combined in one or more embodiments.

“Machine-readable instructions” as referred to herein relates to expressions which may be understood by one or more machines for performing one or more logical operations. For example, machine-readable instructions may comprise instructions which are interpretable by a processor compiler for executing one or more operations on one or more data objects. However, this is merely an example of machine-readable instructions and embodiments of the present invention are not limited in this respect.

A “storage medium” as referred to herein relates to media capable of maintaining expressions which are perceivable by one or more machines. For example, a storage medium may comprise one or more storage devices for storing machine-readable instructions or data. Such storage devices may comprise storage media such as, for example, optical, magnetic or semiconductor storage media. However, this is merely an example of a storage medium and embodiments of the present invention are not limited in this respect.

“Logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a storage medium in combination with processing circuitry to execute such machine-readable instructions. However, these are merely examples of structures which may provide logic and embodiments of the present invention are not limited in this respect.

A “port” as referred to herein relates to a device to transmit or receive information. A port may be characterized as an “ingress” port to receive information from a source coupled to the ingress port. A port may also be characterized as an “egress” port to transmit information to a destination coupled to the port. However, these are merely examples of a port and embodiments of the present invention are not limited in these respects.

A “media port” as referred to herein relates to a port that is adapted to transmit in or receive data from a data transmission medium. A media port may be characterized as having a physical port for transmitting data to or receiving data from a particular data transmission medium. Also, one more single physical ports may be virtualized to appear as one or more media ports to a process or entity communicating with the physical ports such that the process or entity may communicate with the virtualized media ports independently of at least some of the characteristics of the physical ports. However, these are merely examples of a media port and embodiments of the present invention are not limited in these respects.

A “component board” as referred to herein relates to a subsystem of a modular computing or communication platform. A component board may comprise a printed circuit board with circuit components mounted to circuit connections using, for example, solder bonding and/or device sockets. A component board may be physically mounted in a modular platform and comprise connectors to electrically couple devices on the component board to other modular subsystems. A component board may be characterized as a “blade” or “line card” providing a particular subsystem function in a modular platform. However, these are merely examples of a component board and embodiments of the present invention are not limited in these respects.

An “Ethernet frame” as referred to herein relates to a format for transmitting data in a data link according to a protocol provided in versions of IEEE Std. 802.3 (e.g., to transmit data frames according to 10BASE-X, 100BASE-X, 1000BASE-X or 10GBASE-X protocols). An Ethernet frame may include, for example, a header portion including a media access control (MAC) address for a source and a destination, and a payload portion including content data to be processed at a destination. However, this is merely an example of an Ethernet frame and embodiments of the present invention are not limited in these respects.

A “switch” as referred to herein relates to logic to forward received data to one or more destinations. For example, a switch may comprise a plurality of ports and logic to forward data received on an ingress port to an egress port based upon destination information associated with the received data. However, this is merely an example of a switch and embodiments of the present invention are not limited in this respect.

An “Ethernet switch” as referred to herein relates to a switch to forward Ethernet frames received on an Ethernet switch port to one of a plurality of other Ethernet switch ports. For example, an Ethernet switch may forward a received Ethernet frame to an egress Ethernet switch port based upon a destination address (e.g., destination MAC address) in the Ethernet frame. However, this is merely an example of an Ethernet switch and embodiments of the present invention are not limited in these respects.

“ATM cells” as referred to herein relates to units of data used for transmission in connection with an ATM service. ATM cells may be of uniform size (e.g., fifty-six bytes) for transmission of data according to a stream-based communication protocol. ATM cells may be transmitted for providing any one of several ATM services such as, for example, voice data, video data or Internet data services. However, these are merely examples of ATM cells and how they may be used for providing an ATM service, and embodiments of the present invention are not limited in these respects.

Briefly, an embodiment of the present invention relates to a system and method of forwarding ATM cells among component boards in a computing platform over an Ethernet switch. ATM cells received at an ingress media port of component board may be forwarded to a destination component board in a payload portion of an Ethernet data frame. The Ethernet frame may comprise at least one field identifying an egress port of a destination component board for transmitting the forwarded ATM cells. However, this is merely an example embodiment and other embodiments of the present invention are not limited in these respects.

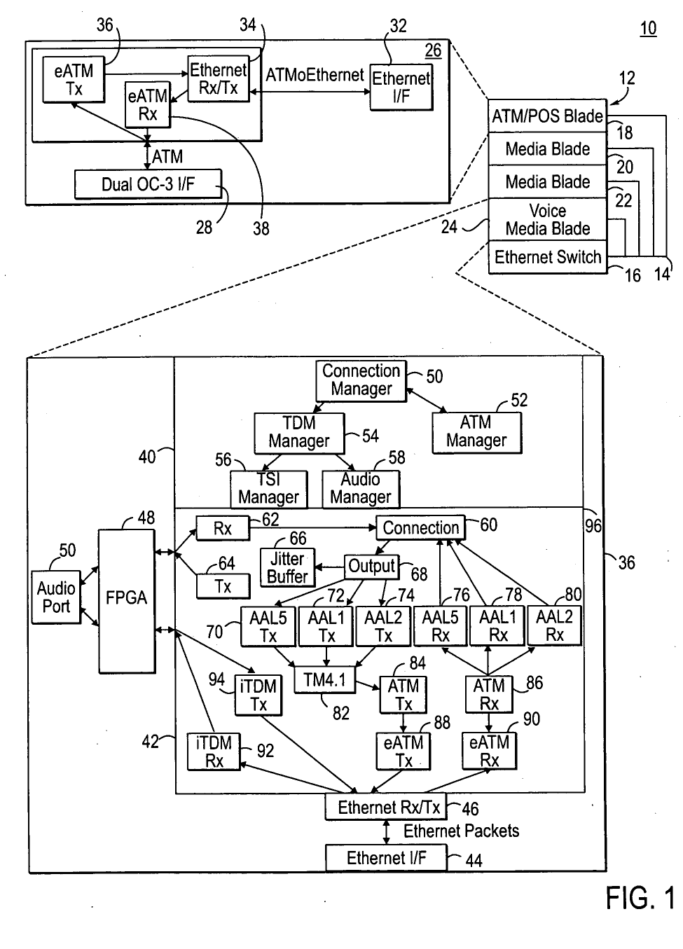

FIG. 1 shows a modular computing platform 12 comprising a plurality of component boards 18 through 24 according to an embodiment of the present invention. The component boards 18 through 24 may each be coupled to an Ethernet switch 16 at a corresponding Ethernet switch port (not shown) through a physical interface 14 and may forward Ethernet frames to one another through the Ethernet switch 16 according to Ethernet switching protocols provided in IEEE Std. 802.3. The component boards 18 through 24 may also each comprise one or more media ports (not shown) for receiving and transmitting data in a data transmission medium according to any one of several communication protocols.

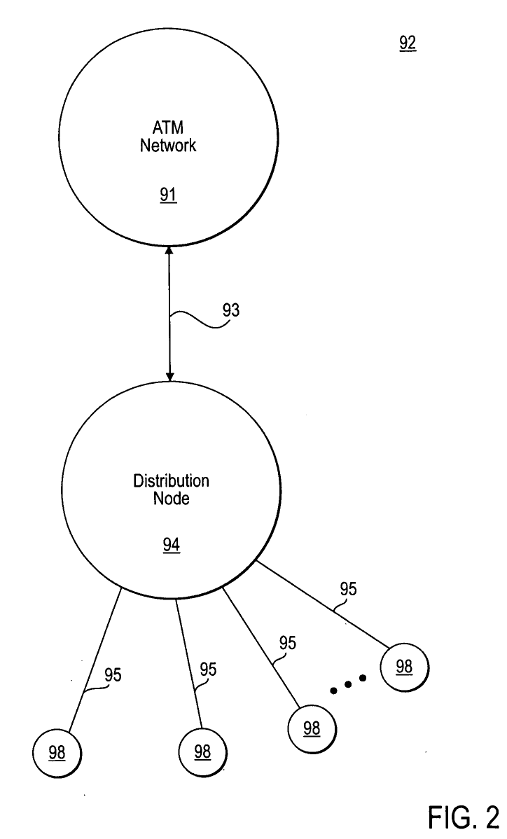

According to an embodiment, the modular computing platform 12 may be used in as part of an end-to-end infrastructure for providing ATM services to subscriber clients as illustrated in FIG. 2. For example, the modular computing platform 12 may be included as part of a distribution node 94 having at least one of the component boards coupled to an ATM network 91 capable of providing one or more ATM services to one or more subscriber client terminals 98. Here, the component board may be coupled to the ATM network 91 by a high speed data link 93 capable of transmitting interleaved ATM cells (such as a Synchronous Optical NETwork (SONET) link capable of transmitting interleaved ATM cells in SONET frames) to support one or more ATM services (e.g., voice data, video data or Internet data) to one or more subscriber client terminals 98. However, this is merely an example of how a distribution node may be coupled to an ATM network and embodiments of the present invention are not limited in these respects. For providing the ATM services to subscriber client terminals 98, the distribution node 94 may comprise equipment to communicate with network elements downstream of the distribution node 94 such as, for example, a DSLAM, cable modem termination system (CMTS) or a wireless transmission base station (not shown). A subscriber client terminal 98 (e.g., personal computer, set-top box, hand held wireless device, broadband modem, etc.) may be coupled to other component boards by any one of several types of data links 95 capable of transmitting ATM cells such as, for example, DSL links, wireless links, coaxial cabling or Ethernet over unshielded twisted wire pair. In other embodiments, a client subscriber terminal 98 may comprise additional telephony equipment (e.g., private branch exchange system) coupled to multiple devices for receiving ATM services. However, these are merely examples of how a subscriber client terminal may be coupled to a distribution node and embodiments of the present invention are not limited in these respects.

In other embodiments, the modular computing platform 12 may be included in a Central Office of a public switched telephone network (PSTN) for routing voice data between local loop subscribers and other points on the PSTN.

According to an embodiment, each of the component boards 18 through 24 may be dedicated to communicating on a data transmission medium according to a particular communication protocol. For example, the component board 18 may comprise one or more media ports (not shown) for transmitting or receiving data according to a SONET protocol. For one or more of the media ports, the component board 18 may comprise a SONET framer, a physical layer data transceiver and forward error correction circuitry to transmit or receive data in SONET frames. The component board 18 may also comprise processing circuitry to provision services using a packet over SONET (POS) protocol including services that may be used to support ATM services. Similarly, the component board 24 may comprise one or more media ports (not shown) for transmitting or receiving voice data (e.g., in a voice over packet format). The component board 24 may comprise processing circuitry to represent voice data in ATM cells for transmission to another component board and generate voice data from ATM cells received from another component board. Alternatively, one or more media ports on any of the component boards 18 through 24 may comprise a UTOPIA bus for coupling processing circuitry used for processing ATM data to physical layer data transceiver. However, these are merely examples of media ports and processing circuitry that may be employed on a component board and embodiments of the present invention are not limited in these respects.

In one embodiment, the Ethernet switch 16 may be provided on a separate component board in the modular computing platform 12 as a switch “blade” adapted to be coupled to a chassis backplane. Alternatively, the Ethernet switch 16 may be formed on one of the component boards 18 through 24 with associated media ports and processing circuitry. The physical interface 14 may comprise, among other things, a device-to-device interconnection such as copper traces formed in one or more printed circuit boards, cabling and electrical connectors suitable for electrically coupling Ethernet switch ports and portions of component boards to one another. In other embodiments, however, the Ethernet switch 16 may be formed as part of a chassis backplane which is coupled to the component boards 18 through 24. However, these are merely examples of how Ethernet switch ports may be coupled to component boards and embodiments of the present invention are not limited in this respect. According to an embodiment, two or more of the component boards may be adapted to transmit or receive ATM cells through one or more of its media ports. Correspondingly, the Ethernet switch 16 may forward ATM cells between component boards in the payload portion of forwarded Ethernet frames.

According to an embodiment, the modular computing platform 12 may be formed according to the Advanced Telecommunications Computing Architecture (ATCA) as illustrated in the PICMG 3.0 Short Form Specification, January 2003. As such, the component boards 18 through 24 may be coupled in a common backplane chassis with a common power supply that enables component boards to be “hot swapped” as modular subsystems. However, this is merely an example of how component boards may be combined in a modular platform and embodiments of the present invention are not limited in this respect.

An exploded view 26 of component board 18 shows an Ethernet interface 32 to be coupled to an Ethernet switch port of Ethernet switch 16 (through physical interface 14) and a media port 28 comprising a SONET framer capable of transmitting and receiving ATM cells in a communication protocol such as POS. However, this is merely an example of a media port that is capable of transmitting or receiving ATM cells in a data transmission medium and embodiments of the present invention are not limited in these respects. Similarly, an exploded view 38 of component board 24 shows an shows an Ethernet interface 44 to be coupled to another Ethernet switch port of Ethernet switch 16 (through physical interface 14) and a media port 50 comprising voice processing circuitry capable of transmitting and receiving digitized audio signals over ATM cells. For example, the media port 50 may be coupled to a voice channel of a private branch exchange (PBX) telephone system. However, this is merely another example of a media port that is capable of transmitting or receiving ATM cells in a data transmission medium and embodiments of the present invention are not limited in these respects.

Processing circuitry 30 in exploded view 26 and processing circuitry 96 in exploded view 38 each comprise logic to packetize ATM cells into the payload portion of Ethernet frames to be transmitted to another component board through the Ethernet switch 16, and similarly de-packetize ATM cells from Ethernet frames received from the Ethernet switch 16. In the presently illustrated embodiment, processing circuitry 96 may comprise a controller 40 to manage communications between audio channels and a forwarding engine 42 to packetize and de-packetize ATM cells into the payload portion of Ethernet frames. The controller 40 may execute processes 50 through 58 to establish and terminate sessions with processes communicating with the component board 24 through the media port 50. During such sessions, the forwarding engine 42 may execute processes such as processes 70 through 80 to perform ATM stack processing in support of one or more ATM services. Process 88 may encapsulate ATM cells in Ethernet frames for transmission through Ethernet switch 16 as described below with reference to FIG. 4. Similarly, process 90 may extract ATM cells from Ethernet frames received from the Ethernet switch 16 for ATM processing.

The processing circuitry 30 and 96 may comprise any one of several types of network processing devices such as, for example, a programmable network processor (e.g., IXP 2400 network processor sold by Intel Corporation) or an ASIC. However, these are merely examples of processing circuitry that may be used for processing ATM cells for transmission in Ethernet frames and embodiments of the present invention are not limited in these respects.

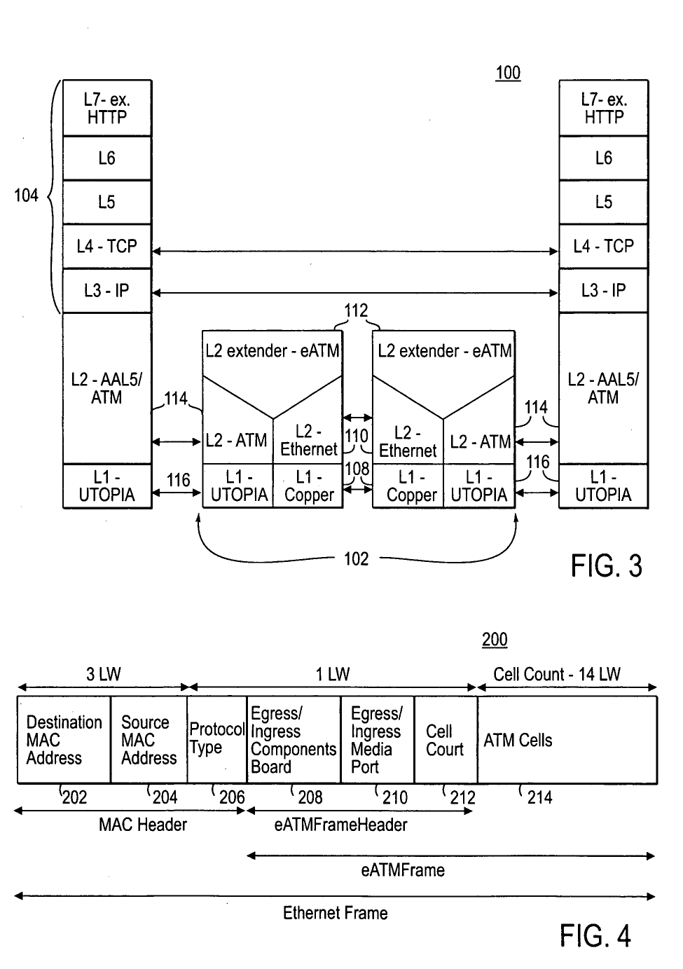

FIG. 3 illustrates a protocol for transmitting ATM cells between component boards through an Ethernet switch according to an embodiment of the modular computing platform 12 shown in FIG. 1. At a physical layer (L1) 108 and data link layer (L2) 112, the Ethernet switch 16 may transmit Ethernet frames between component boards using Ethernet according to IEEE Std. 802.3. While L1 108 is shown as copper in FIG. 3, it should be understood that other physical media suitable for switching Ethernet frames between component boards (e.g., optical media) may be used. As illustrated with reference to FIG. 4, ATM cells may be encapsulated in the payload portions of the transmitted Ethernet frames as part of a data link layer extender (eATM) 112. In encapsulating ATM cells in the Ethernet frames, the processing circuitry at a transmitting component board may direct ATM cells to particular egress media ports of a receiving component board. Processing circuitry at the receiving component board may then direct ATM cells de-packetized from Ethernet frames to a particular egress media port 116. The transmission of the ATM cells between the component boards may then support ATM services on protocol layers 104 as illustrated.

FIG. 4 shows a format of an Ethernet frame 200 for transmitting ATM cells between component boards according to an embodiment of the protocol illustrated in FIG. 3. Fields 202, 204 and 206 provide a destination MAC address, source MAC address and protocol type, respectively, as part of a MAC header according to IEEE Std. 802.3. Field 206 may identify the payload portion of Ethernet frame 200 as having ATM cells for transmission according to the protocol described with reference to FIG. 3. Field 214 contains ATM cells that are encapsulated in the Ethernet frame for transmission between component boards. Fields 208, 210 and 212 may form a packet header to identify a destination component board and egress media port for the encapsulated ATM cells.

Processing circuitry at a transmitting component board may forward ATM cells encapsulated in field 214 of Ethernet frame 200 through Ethernet switch 16 to a destination egress media port of a destination component board by specifying the destination component board in field 208 (If the Ethernet frame 200 is an outbound the field 208 may indicate an “egress” component board and if the Ethernet frame is inbound the field 208 may indicate an “ingress” component board). The processing circuitry may similarly specify a particular destination media port (of the destination component board) in field 210. Alternatively, each component board may be associated with a MAC address such that a destination component board may be identified by its MAC address in field 202. Upon receipt of the Ethernet frame 200 at the destination component board, processing circuitry may forward the ATM cells to the destination media port identified in field 210. Field 210 may be used to identify a physical media port or virtual media port (e.g., through the emulation of multiple UTOPIA buses on a line card) that is adapted to transmit the ATM cells in field 214 over any one of several physical media ports for transmitting ATM cells as defined by the Optical Internetworking Forum or a SONET port.

In the presently illustrated embodiment, fields 202 and 204 may each be forty-eight bits to equal three 32-bit words while fields 206, 208, 210 and 212 may be sixteen bits, four bits, four bits and eight bits, respectively. Taking a total of four 32-bit words, the combination of fields 202 through 212 may be stored in or retrieved from a memory device (e.g., random access memory accessible by processing circuitry on a component board), with four 32-bit memory cycles or two 64-bit memory cycles. Accordingly, processing circuitry receiving the Ethernet frame 200 may forward the ATM cells in field 214 based upon information retrieved from these memory cycles. However, this is merely an example of how fields in an Ethernet frame may be partitioned for encapsulating ATM cells in an Ethernet frame and embodiments of the present invention are not limited in these respects.

By forwarding the ATM cells in Ethernet frames according to the protocol described above, processing used to provide ATM based services to a client subscriber terminal may be distributed to the affected component boards of a modular communications platform. Using programmable network processing circuitry, for example, the ATM based services may be modified by updating the associated software of the affected component boards while making little or no modification to the unaffected processing boards. Also, by using a standard Ethernet switch the transmit data between component boards in the modular computing platform, component boards providing ATM services may be combined with component boards that do not provide ATM services in the same modular platform. By using standard Ethernet switching to transmit data between component boards, Ethernet frames may be used to transmit non-ATM traffic in addition to ATM traffic to support other Ethernet enabled protocols (such as Simple Network Management Protocol (SNMP) for platform management, Internet Protocol routing or MPLS) without the need for different physical connectors.

While there has been illustrated and described what are presently considered to be example embodiments of the present invention, it will be understood by those skilled in the art that various other modifications may be made, and equivalents may be substituted, without departing from the true scope of the invention. Additionally, many modifications may be made to adapt a particular situation to the teachings of the present invention without departing from the central inventive concept described herein. Therefore, it is intended that the present invention not be limited to the particular embodiments disclosed, but that the invention include all embodiments falling within the scope of the appended claims.

1. An apparatus comprising:
an Ethernet switch comprising a plurality of Ethernet switch ports;
a plurality of component boards, each component board being coupled to an associated one of the Ethernet switch ports, at least one of the plurality of component boards comprising:
an ingress media port to receive ATM cells from a data transmission medium;
logic to forward the ATM cells in a payload of an Ethernet frame, the Ethernet frame comprising at least one field identifying an egress media port of a destination component board for transmitting the forwarded ATM cells.

2. The apparatus of claim 1, wherein the at least one field identifies an egress media port from among a plurality of egress media ports of the destination component board.

3. The apparatus of claim 1, wherein the Ethernet frame comprises a first field identifying the destination component board and a second field identifying the egress media port.

4. The apparatus of claim 3, wherein the first field comprises a destination MAC address field.

5. The apparatus of claim 1, wherein the egress media port comprises a UTOPIA port.

6. The apparatus of claim 1, wherein the egress media port comprises a SONET port.

7. The apparatus of claim 1, wherein at least one of the component boards comprises logic to process data packets in Ethernet frames received from the Ethernet switch according to a Simple Network Management Protocol.

8. A component board comprising:
at least one ingress media port adapted to receive ATM cells from a data transmission medium; and
processing circuitry adapted to be coupled to an Ethernet switch port, the processing circuitry comprising logic to forward the ATM cells through the Ethernet switch port in a payload of an Ethernet frame, the Ethernet frame comprising at least one field identifying an egress media port of a destination component board for transmitting the forwarded ATM cells.

9. The component board of claim 8, wherein the component board further comprises a plurality of egress media ports, each egress media port being adapted to transmit ATM cells to a destination, and wherein the processing circuitry further comprises:
logic to receive ATM cells encapsulated in a payload of an Ethernet frame; and
logic to select one of the egress media ports to forward the received ATM cells based, at least in part, on a field in the Ethernet frame identifying the selected egress media port.

10. The component board of claim 8, wherein the component board is adapted to be coupled to an ATCA backplane.

11. The apparatus of claim 8, wherein the at least one field identifies an egress media port from among a plurality of egress media ports of the destination component board.

12. The apparatus of claim 11, wherein the first field comprises a destination MAC address field.

13. The apparatus of claim 8, wherein the Ethernet frame comprises a first field identifying the destination component board and a second field identifying the egress media port.

14. The apparatus of claim 8, wherein the egress media port comprises a UTOPIA port.

15. The apparatus of claim 8, wherein the egress media port comprises a SONET port.

16. A method comprising:
receiving a sequence of ATM cells from a data transmission medium at an ingress media port; and
forwarding at least some of the ATM cells in a payload of an Ethernet frame to a destination component board, the Ethernet frame comprising at least one field identifying an egress port of the destination component board for transmitting the forwarded ATM cells.

17. The method of claim 16, wherein forwarding at least some of the ATM cells in a payload of an Ethernet frame further comprises:
receiving the Ethernet frame at an Ethernet switch comprising a plurality of Ethernet switch ports; and
transmitting the received Ethernet frame to the destination component board on one of the Ethernet switch ports coupled to the destination component board based, at least in part, on a field identifying the destination component board.

18. The method of claim 16, wherein the at least one field identifies an egress media port from among a plurality of egress media ports of the destination component board.

19. The method of claim 18, wherein the first field comprises a destination MAC address field.

20. The method of claim 16, wherein the Ethernet frame comprises a first field identifying the destination component board and a second field identifying the egress port.

21. An article comprising:
a storage medium comprising machine-readable instructions stored thereon to:
de-packetize a sequence of ATM cells received from a data transmission medium; and
forward at least some of the ATM cells in a payload of an Ethernet frame to a destination component board, the Ethernet frame comprising at least one field identifying an egress port of the destination component board for transmitting the forwarded ATM cells.

22. The article of claim 21, wherein the storage medium further comprises machine-readable instructions stored thereon to:
de-packetize ATM cells from an Ethernet frame received from an Ethernet switch; and
forward the de-packetized ATM cells de-packetized from the Ethernet frame to an egress media port based, at least in part, on a.

23. The article of claim 21, wherein the at least one field identifies an egress media port from among a plurality of egress media ports of the destination component board.

24. The article of claim 23, wherein the first field comprises a destination MAC address field.

25. The article of claim 21, wherein the Ethernet frame comprises a first field identifying the destination component board and a second field identifying the egress port.

26. A system comprising:
an ATM network to provide one or more ATM services;
a plurality of subscriber client terminals, each subscriber client terminal being capable of receiving one or more ATM services from the ATM network; and
an ATM distribution node, the ATM distribution node comprising:
an Ethernet switch comprising a plurality of Ethernet switch ports;
a plurality of component boards, each component board being coupled to an associated one of the Ethernet switch ports, at least one of the of component boards comprising an ingress media port to receive ATM cells from the ATM network and logic to forward the ATM cells in a payload of an Ethernet frame, the Ethernet frame comprising at least one field identifying an egress media port of a destination component board for transmitting the forwarded ATM cells.

27. The system of claim 26, the system further comprising a SONET link coupled between the ATM network and the ingress media port of the at least one of the component boards.

28. The system of claim 26, wherein the ATM network comprises logic to transmit ATM cells to the ingress media port according to a packet over SONET protocol.

29. The system of claim 26, the system further comprising at least one DSL link coupled between a media port of one of the component boards and at least one client subscriber terminal.

30. The system of claim 26, wherein the ATM network is capable of providing at least one of a voice data service and video data service at least one of the subscriber client terminals.
